(19) United States
(12) Patent Application Publication
(10) Pub. No.: US 2010/0053948 A1
(43) Pub. Date: Mar. 4, 2010

(54) DEVICE FOR MIXING LIGHT OF SIDE EMITTING LEDS

(75) Inventors: Paulus Gerardus Henricus Kosters, Eindhoven (NL); Lars Rene Christian Waumans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/447,680

(22) PCT Filed: Oct. 26, 2007
(86) PCT No.: PCT/IB07/54356

§ 371 Date: Apr. 29, 2009

(30) Foreign Application Priority Data
Nov. 2, 2006 (EP) 06123368.0

(51) Int. Cl. F21V 9/00; F21V 1/00

(52) U.S. Cl. 362/231; 362/235

(57) ABSTRACT

A light emitting device (100) is provided that comprises a longitudinally elongated housing (101) comprising a top wall (102) and opposing diffusing surface (103), and two mutually opposing reflective longitudinally elongated sidewalls (104) connecting said top wall (102) with said diffusing surface (103). An array of mutually spaced apart light emitting diodes (105) arranged is in said housing along the longitudinal extension thereof, and at least one of said sidewalls (104) is provided with an array of mutually spaced apart light redirecting means (106). The light redirecting means reflect light away from the LED that emitted the light, leading to a good mixing of light from the LEDs in the array.

### FIELD OF THE INVENTION

The present invention relates to a light emitting device that comprises a longitudinally elongated housing, comprising a top wall and an opposing diffusing surface, and two mutually opposing reflective longitudinally elongated sidewalls connecting said top wall with said diffusing surface, and an array of mutually spaced apart light emitting diodes arranged in said housing along the longitudinal extension thereof. The present invention also relates to such a housing it self.

### BACKGROUND OF THE INVENTION

Color mixing for indoor lighting has become more and more important the last years. Using LED's for color mixing can make it possible to have more extreme color variations in a smaller volume.

Color mixing of a row of LEDs may for example be done by mixing light from the LEDs on an optical diffuser. The distance between the LEDs presents a limitation to such a lighting system, because the intensity should remain at an essentially constant level along the direction of the row.

In general, this leads to that the distance between LEDs should be equal or smaller than the distance between the LED and the diffuser. Hence, in order to maintain the constant luminance level, it is not possible to reduce the amount of LEDs by increasing the distance between them without simultaneously increasing the distance between the LEDs and the diffuser.

In a row of LEDs, up to about 40% of the light directly below a LED emanates from that specific LED. Hence, it is indeed often required to place the LEDs even closer together, especially in a row of LEDs emitting light of different colors, to obtain an acceptable color mixing over the whole area.

Side reflectors are often used to direct all the light emanating from the LEDs towards the diffuser and thereby generating a luminance profile perpendicular to the row of LEDs.

Side emitting light emitting diodes (SE-LEDs) have been proposed as the light sources in such a row of LEDs, since a bigger portion of the light from a SE-LED is spread farther away from the source. However, the distance between the LEDs still presents a limitation, and when using SE-LEDs, the distance between SE-LEDs may be 1.5 times the distance between the LED and the diffuser, while maintaining an essentially constant intensity level along the row of LEDs.

Thus, there is a need in the art for a light emitting device based on a row of light emitting diodes, where the distance between the LEDs may be further increased while maintaining the color mixing and intensity homogeneity.

### SUMMARY OF THE INVENTION

It is an object of the present invention to at least partly overcome the problems of the prior art and to provide a light-emitting device based on side emitting LEDs that provide good color mixing properties over the whole device.

It is another object of the present invention to provide a light-emitting device based on a row of LEDs that provide good intensity homogeneity over the length of the row.

The present inventors have found that the above objects at least partly can be met by directing at least part of the light from each LED away from that LED, by arranging light directing means on the surface of the side reflectors of the light emitting device.

Thus, in a first aspect, the present invention provides a light emitting device that comprises a longitudinally elongated housing comprising a top wall, an opposing diffusing surface and two mutually opposing reflective longitudinally elongated sidewalls connecting said top wall with said diffusing surface. An array of mutually spaced apart light emitting diodes (LEDs) is arranged in said housing, along the longitudinal extension thereof. At least one of said sidewalls is provided with an array of mutually spaced apart light redirecting means, said light redirecting means extending, along a direction transversely to the longitudinal extension of said housing, from said top wall towards said diffusing surface.

Light from an LED incident on a light redirecting means is, to a large extent, reflected away from that LED due to that light is reflected on surfaces of the light redirecting means that are not perpendicular to the direction of light from the LED. At the diffusing surface, the light from that LED will thus be mixed with light from other LEDs. Hence, a good color mixing is obtained over the whole surface of the device.

The light redirecting means may typically be inward projecting protrusions or outward projecting recesses, preferably protrusions for maximum light mixing.

In embodiments of the present invention, the length of the light redirecting means in said direction transversely to the longitudinal extension of said housing, from said top wall towards said diffusing surface, is less than the distance between the top wall and the diffusing surface.

The first reflection on the sidewalls will mainly take place in the upper portion thereof, where the light redirecting means are present. After the first reflection, the light should preferably be reflected on straight flat sidewalls, to transport the light as far as possible from the LED, until it encounters the diffuser and is emitted out of the light-emitting device. By not having any light redirecting means near the diffusing surface, less light will be reflected back towards the emitting LED.

In embodiments of the present invention, the light emitting diodes of the array are side-emitting light emitting diodes.

Side-emitting light emitting diodes emit light in directions having a major component along the plane of the surface on which they are mounted. In the present invention, the side-emitting light emitting diodes are typically arranged on, or parallel to, the inner surface of the top wall. Hence, a large portion of the light will be reflected on the sidewalls, yielding a good mixing of light from different LEDs. Due to this, the inter-LED distance may be increased further, while maintaining good color mixing and intensity homogeneity.

In embodiments of the present invention, the light redirecting means are arranged such that light, which is emitted by an LED in a direction transversely to the longitudinal extension of said housing and parallel to the top wall, will be reflected on one of said light redirecting means. Typically, the distance between two adjacent light redirecting means corresponds to the distance between two adjacent side emitting LEDs.

With the light redirecting means located accordingly, the light emitted in transversely to the elongation of the housing, and thus being perpendicular to the general surface of the sidewalls is reflected away from the LED instead of directly back towards it. This increases the light mixing, since only a small portion of the light incident on a certain area of the diffusing surface will emanate from the LED arranged directly above that area.

In embodiments of the present invention, the light redirecting means are protrusions where the height of said protrusions, counted in the direction between said sidewalls, decreases with the distance from said top wall, or where the light redirecting means of are recesses where the height of said recesses increases with the distance from the top wall.

This design of the light redirecting means further increases the light mixing of light from adjacent LEDs. Due to the gradually decreasing height of the protrusions/increasing height of the recesses light reflected on such a protrusion will be directed more towards the diffusing surface than before the reflection. Hence, the risk for back-reflection towards the area of the diffusing layer located under the originating LED is reduced.

In embodiments of the present invention, the array of LEDs comprises at least a first LED for emitting light of a first wavelength spectrum and a second LED for emitting light of a second wavelength spectrum.

The light from LEDs emitting different wavelength spectra is successfully mixed in a device of the present invention.

In embodiments of the present invention, the surface of said top wall facing said diffusing surface may be reflective. This will increase the light utilization efficiency of the device, since more of the emitted light, for example light emitted towards the top wall, will reach the diffusing surface.

In a second aspect, the present invention relates to the above described housing as such, especially for use in a light-emitting device.

### BRIEF DESCRIPTION OF THE DRAWINGS

This and other aspects of the present invention will now be described in more detail, with reference to the appended drawings showing a currently preferred embodiment of the invention.

FIG. 1 illustrates, in partly cut-away perspective view, a first embodiment of a light-emitting device of the present invention.

FIG. 2 illustrates, in cross-sectional view, the embodiment of FIG. 1.

FIG. 3 illustrates, in partly cut-away perspective view, a second embodiment of a light-emitting device of the present invention.

FIG. 4 illustrates, in cross-sectional view, the embodiment of FIG. 3.

### DETAILED DESCRIPTION

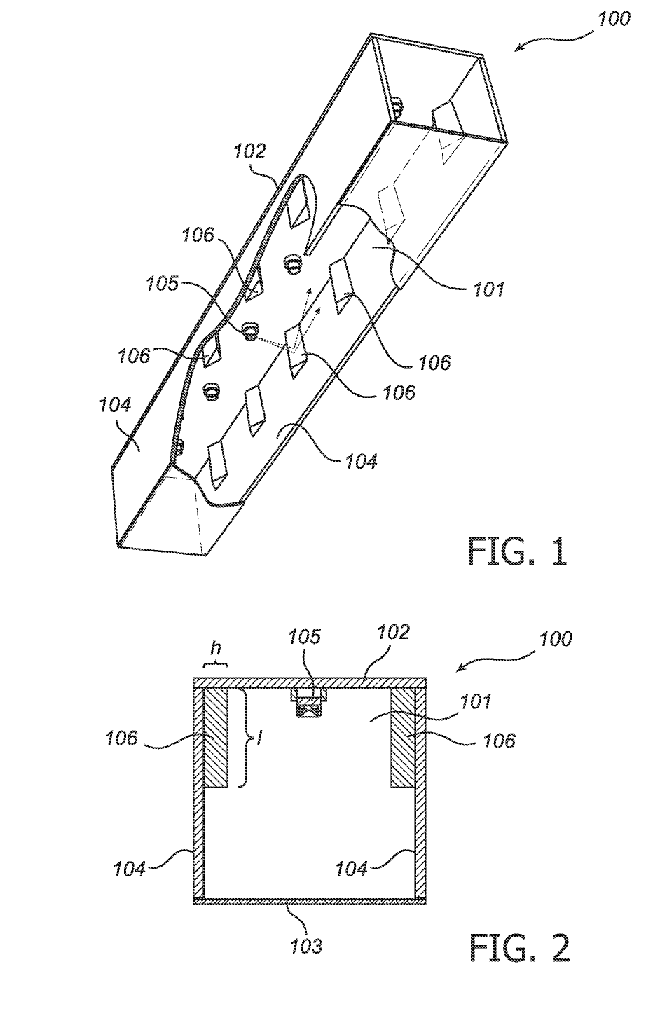

An exemplary embodiment of a light-emitting device 100 according to the present invention is illustrated in FIGS. 1 and 2, and comprises a housing 101 and an array of light emitting diodes 105 arranged in a row.

The housing 101 is longitudinally extended and comprises a top wall 102, an opposing diffusing surface 103, and two mutually opposing elongated sidewalls 104 that connects the top surface and the diffusing surface.

The housing 101 it self represents a separately contemplated aspect of the present invention, even though it in the following description is described as a component of a light emitting device.

The array of mutually spaced apart LEDs 105 is arranged on the top surface, along the longitudinal extension of the housing, facing the diffusing surface 103 (i.e. inside the housing).

The top wall 102 is longitudinally elongated along with the housing. The inside surface of the top wall 102, i.e. the surface that faces the diffusing surface 103 is typically reflective, at least for the light emitted by the light emitting diodes 105. Hence, light emitted by the diodes 105 being incident on the inner surface of the top wall 102 will be reflected towards the diffusing surface 103.

The reflective surface may be a specular or glossy surface or a matt, white reflective surface.

As used herein, the term “reflective surface” refers to a surface that reflects at least part of the light incident on the surface, since it is often inevitable that at least a small portion of the incident light is absorbed by the surface.

The diffusing surface 103 is longitudinally elongated and is typically essentially parallel to the top wall 102 and is made of a transmissive and diffusing material, so that light from incident on the diffusing surface 103 is transmitted through the surface and distributed randomly, diffused, to the outside of the housing 101. Typical materials for the diffusing surface 103 includes, but are not limited to PMMA, Polystyrene and Polycarbonate.

The sidewalls 104 are longitudinally extended and connect the long sides of the top wall 102 with the long sides of the diffusing surface 103. Further, the inner surfaces of the sidewalls are reflective, at least for light of the wavelengths emitted by the light emitting diodes 105.

The light emitting diodes 105 are arranged mutually spaced apart as an array on the inner surface of the top wall 102.

Preferably, the light emitting diodes 105 are side-emitting light emitting diodes, since the color mixing effect of the housing is greatest for side emitting LEDs.

Many examples of side emitting light emitting diodes are known to those skilled in the art, and include, for example, the Luxeon side emitter LED. The term “side-emitting”, as used herein in connection with light emitting diodes refers to that such a large portion of the light emitted by the diode is emitted in directions having a major component along the plane on the substrate that is arranged on, here the inner surface of the top wall 102. However, the present invention may also be used for mixing light of other types of LEDs, such as batwing LEDs and LEDs having a Lambertian emission pattern.

The term “light emitting diode” (herein abbreviated “LED”) as used herein refers to any type of light emitting diodes known to those skilled in the art, such as inorganic based LEDs and organic based LEDs, such as small organic molecule based LEDs and polymeric based LEDs. The term LED is also intended to encompass laser-emitting diodes. The term also relates to LEDs emitting light of any wavelength in the wavelength range of from ultra-violet to infra red light, especially LEDs emitting light in the visible range.

The LEDs 105 of the array are typically of different colors, in that they emit light of different wavelength spectrums. Thus, in the array, LEDs of different colors are adjacent to each other. The device of the present invention may also be used to mix light from different LEDs emitting different color temperatures, such as different white light.

The LEDs are connected to a driving circuitry providing the driving power to the LEDs. The circuitry may for example be arranged on the outside of the top wall 102 and connected to the LEDs via through holes in the top wall and/or may be arranged on the inner surface of the top wall 102.

A portion of the light emitted by the light emitting diodes 105 is directed towards the reflective sidewalls 104. Since the sidewalls 104 and the inner surface of the top wall 102 is reflective, the light emitted will be reflected until it eventually becomes incident on the diffusing surface, where after it is transmitted out of the housing.

The sidewalls 104 are provided with a plurality of light redirecting means, here in the form of a plurality of inward projecting protrusions 106 (i.e. the apex of a protrusion on one sidewall projects generally towards the opposing sidewall).

The protrusions 106 are arranged on the sidewalls such that light from a certain LED 105 located closest to, and incident on, each protrusion is preferentially reflected away from that LED. Thus, light emitted by an LED 105 and incident on the closest protrusion 106 is reflected in a direction other than back towards the same LED.

In alternative embodiments, the plurality of light redirecting means may be in the form of a plurality of outward projecting recesses (i.e. the apex of a recess in one sidewall projects generally away from the opposing sidewall), or a mixture of both protrusions and recesses.

In yet alternative embodiments, a light redirecting means may comprise a plurality of discrete such protrusions or recesses, which collectively forms a light redirecting means which extends from the top wall towards the reflective surface.

The array of protrusions 106 is aligned to the array of LEDs 105 such that the distance between adjacent light redirecting means corresponds to the inter-LED distance. Light from a LED 105 emitted in the direction transversely to the longitudinal extension of the housing 101 and along the surface of the top wall 102 is incident on a protrusion 106 and reflected in a different, non-parallel direction.

The cross-sectional shape of the light redirecting means, transversely to the extension of the light redirection means, determines the direction in which light is reflected. Typically, the light redirection means have a triangularly shaped cross-section with straight or curved sides. However, other cross-sectional shapes are also possible, such as rounded shapes, for example half-circle or circle-segment shaped cross-sections.

For example, the light redirection means may be formed on the sidewalls by folding the sidewall material to the desired shape, or alternatively by arranging protrusion material on the sidewalls.

The protrusions 106 extend essentially from the inner surface of the top wall 102 down the sidewalls 104 towards the diffusing surface 103, along a direction essentially transversely to the longitudinal extension of the housing.

In the embodiment illustrated in the figures, the length (l) of the protrusions 106 in this direction, i.e. essentially transversely to the longitudinal extension of the housing, is less than the height of the sidewalls, in the same direction, i.e. the distance between the top wall 102 and the diffusing surface 103.

Hence, the protrusions 106 do not extend over the whole height of the sidewalls 104, but does only extend over the upper portion of the sidewall (i.e. the portion located towards the top wall 102).

In other words, the sidewalls 104 are divided, along the longitudinal direction of said housing, into an upper domain towards said top surface and a lower domain towards said diffusing surface, where the protrusions 106 extend over the height of the upper domain, and where the protrusions 106 does not extend into the lower domain.

Since most of the direct light emitted by side emitting LEDs arranged at the top wall will be reflected on the upper side of the side wall, the protrusions are only required in this part, since this is the area where the first reflection of the light with the side wall will occur. The absence of protrusions in the lower part of the side emitter wall ensure a limited back bouncing of light towards the LEDs and thus a good color mixing.

Typically, the length (l) of the protrusion is up to 70% of the height of the sidewalls. However, the optimal length will depend on the geometry of the light-emitting device.

In embodiments of the present invention, the height h of the protrusions, counted in the direction parallel to the surface of the top wall and transversely to the longitudinal extension of the housing 101, decreases with the distance from the top wall 102, such that the protrusion profile gradually disappear from the cross section of the sidewall when approaching the diffusing surface.

Alternatively, in cases where the light redirection means are recesses, the height increases with the distance from the top wall, such that the recess profile gradually becomes more accentuated in the cross section of the sidewall when approaching the diffusing surface.

The lower domain of the sidewalls, towards the diffusing surface, is an essentially flat reflective surface. The reflective surface of the sidewalls may be a glossy surface or a matt, white reflective surface.

The inter-LED distance in the array is typically about 0.5 to 2.5 times the height of the housing, i.e. the distance between the top wall and the diffusing surface. Especially, due to the light redirecting means on the sidewalls, the inter-LED distance may be at least 1.5 times the height of the housing, while still maintaining good light mixing.

The inter-LED distance in the array is typically about 10 to 30 mm, depending on the dimensions of the light-emitting device.

The width of the housing, i.e. the distance between the two opposing sidewalls 104 is typically 200 to 1500% of the inter-LED distance, typically 20 to 150 mm.

The length l of the light redirecting means is typically 30 to 100%, preferably 30 to 70%, of the height of the housing.

One object of the present invention is to provide well-mixed light from a row (an array) of light emitting diodes. Especially, one object is to provide color mixing from a row of side emitting LEDs emitting light of different wavelength spectrums, i.e. different colors and/or different color temperatures.

The light emitted from the LEDs 105 in a direction having a major component along the inner surface of the top wall 102 will fall onto the upper domain of the sidewalls, i.e. the protrusion-containing domain of the sidewall.

The light incident on the upper domain of the sidewalls will be reflected back and forth between the two opposite sidewalls until it finally reaches the diffusing surface 103.

The lower domain of the sidewalls is preferably flat to avoid light bouncing back at a non-adjacent protrusion.

Since light emitted transversely to the longitudinal extension of the housing 101 will be reflected away from the LED emitting that light, only a minor amount of the light incident on the diffusing surface 103 directly below a certain LED will emanate from that LED. Hence a very good mixing of light is obtained, and in the case where adjacent LEDs emit light of different color, the color mixing will be very good.

The proposed design of the housing 101 yields a very good color mixing and a light from each of the LEDs 105 is distributed over a large area on the diffusing film. Hence, the number of LEDs per length unit can be reduced, in comparison with a housing without the protrusions 106 on the sidewalls, while maintaining good color mixing.

In the prior art light emitting device, with a housing without the protrusions, the distance between adjacent LEDs can be maximum 1.5 times, preferably not more than 1 time, the distance between the LED and the diffusing surface, in order to provide good color mixing.

However, in a light-emitting device of the present invention, with the protrusions on the sidewalls, the distance between adjacent LEDs can be substantially larger than 1.5 times the distance between the LEDs and the diffusing surface.

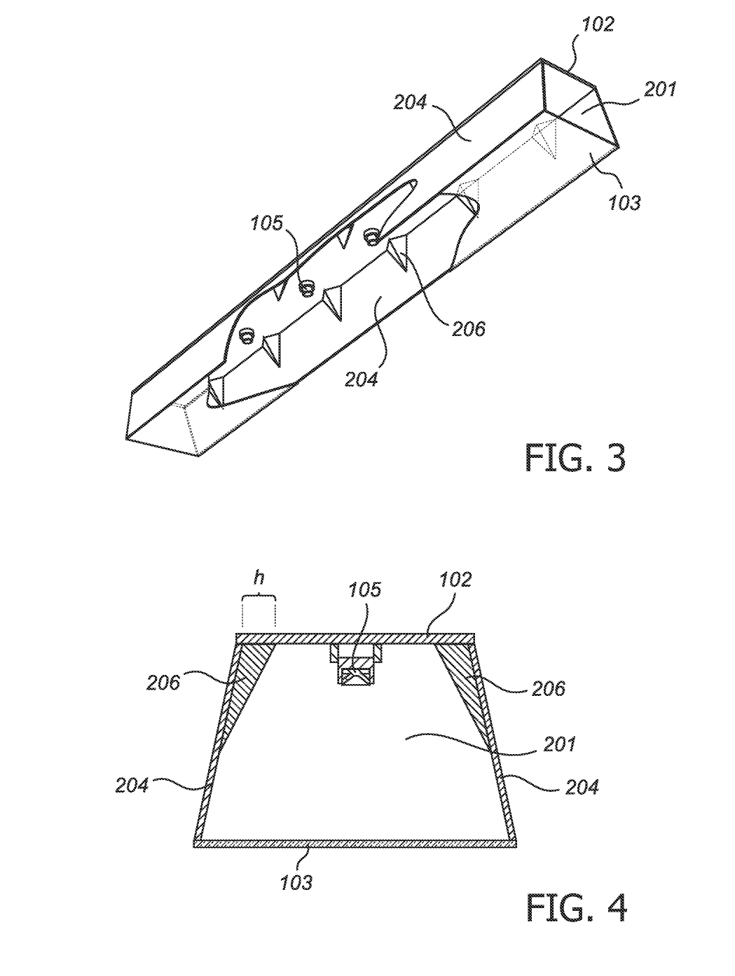

In a second embodiment of the present invention, as illustrated in FIGS. 3 and 4, the height h of the protrusions 206, counted in the direction from one sidewall to the opposing sidewall, transversely to the longitudinal extension of the housing 201, decreases with the distance from the top wall 102. Hence, the protrusion's profile gradually disappears from the cross section of the sidewall when approaching the diffusing surface, leading to even a better color mixing.

The detailed design of the protrusions depends on the exact geometry of the light-emitting device. Thus, starting with a give light emitting device geometry, the shape of the protrusions can be used to optimize color mixing.

Further, in this embodiment, the distance between the opposing sidewalls 204 increases with the distance from the top wall 102, such that the housing 201 has a funnel shaped cross-section transversely to the longitudinal extension thereof. This design will achieve a collimation of the light emitted by the LEDs.

The person skilled in the art realizes that the present invention by no means is limited to the preferred embodiments described above. On the contrary, many modifications and variations are possible within the scope of the appended claims. For example, the light emitting device may comprise also an additional array of LEDs which is arranged essentially parallel to the above described array of LEDs, with the same or different inter-LED distance.

Further, even though it presently is preferred to arrange the light emitting diodes on the inner surface of the top wall of the housing, the light-emitting device of the present invention is not limited to this fact. The light emitting diodes may in alternative embodiments be arranged at a distance from the top wall, for example being attached to and protruding from the sidewalls of the housing, or hanging from the top wall.

1. A light emitting device, comprising:
a longitudinally elongated housing comprising a top wall, an opposing diffusing surface, and two mutually opposing reflective longitudinally elongated sidewalls connecting said top wall with said diffusing surface, and
an array of mutually spaced apart light emitting diodes arranged in said housing along the longitudinal extension thereof, wherein
at least one of said sidewalls comprises an array of mutually spaced apart light redirecting means, and
said light redirecting means extend, along a direction transversely to the longitudinal extension of said housing, from said top wall towards said diffusing surface.

2. A light-emitting device according to claim 1, wherein said light redirecting means comprises inward projecting protrusions.

3. A light emitting device according to claim 1, wherein the length (l) of said light redirecting means in said direction transversely to the longitudinal extension of said housing, from said top wall towards said diffusing surface, is less than the distance between said top wall (and said diffusing surface.

4. A light-emitting device according to claim 1, wherein said light emitting diodes are side emitting light emitting diodes.

5. A light emitting device according to claim 1, wherein said light redirecting means are arranged such that direct light, emitted by an LED in a direction transversely the longitudinal extension of said housing and parallel to the top wall 102, will be reflected on one of said light redirecting means.

6. A light emitting device according to claim 1, wherein the distance between two adjacent light redirecting means corresponds to the distance between two adjacent side emitting LEDs.

7. A light emitting device according to claim 2, wherein the height (h) of said protrusions, counted in the direction between said sidewalls, decreases with the distance from said top wall.

8. A light emitting device according to claim 1, wherein said array of LEDs comprises at least a first LED for emitting light of a first wavelength spectrum and a second LED for emitting light of a second wavelength spectrum.

9. A light emitting device according to claim 1, where the surface of said top wall facing said diffusing surface is reflective.

10. (canceled)
